(19) United States
(12) Patent Application Publication
(10) Pub. No.: US 2014/0055264 A1
(43) Pub. Date: Feb. 27, 2014

(54) Theft Detection System

(71) Applicants: Thomas E. Valiulis, Rockford, IL (US); Chan Chor Man, Tai Po (HK)

(72) Inventors: Thomas E. Valiulis, Rockford, IL (US); Chan Chor Man, Tai Po (HK)

(73) Assignee: SOUTHERN IMPERIAL, INC., Rockford, IL (US)

(21) Appl. No.: 13/591,040

(22) Filed: Aug. 21, 2012

(51) Int. Cl. G08B 13/14

(52) U.S. Cl. 340/568.1

(57) ABSTRACT

A theft detection system is provided. In one embodiment, the theft detection system includes a theft detection device configured to be coupled to a product to detect theft of the product. In one embodiment, the theft detection system also includes a deactivator configured to emit a signal including a predetermined code. In one embodiment the theft detection device includes a sensor configured to receive a signal, and, if the signal includes the predetermined code, to deactivate the theft detection device.

### FIELD OF THE INVENTION

This invention generally relates to theft detection systems, and, more particularly, to theft detection systems for use in a retail environment.

### BACKGROUND OF THE INVENTION

The retail industry looks to prevent loss due to theft. Therefore, many retail environments include theft deterrence systems. Some retail environments may provide systems such as an electronic article surveillance (EAS) system, in which gates may be located proximate the exit to the retail environment. In such a system, a tag may be placed on merchandise, and if an EAS gate senses a tag passing through it, it sounds an alarm.

In other systems various other theft detection devices such as tags may be placed on products. Typically, the theft detection device must be turned off or removed from a product upon purchase of the product by a consumer. Typical devices for turning off or removing theft detection devices include keys, magnetic detachers, deactivator pads, infrared remote controls, etc.

### BRIEF SUMMARY OF THE INVENTION

One embodiment of the invention relates to a theft detection system. The theft detection system includes a theft detection device configured to be coupled to a product. The theft detection device includes a receiver configured to receive a signal. The theft detection device also includes a controller. The controller is configured to determine whether the signal received by the receiver includes a code. The theft detection device has a first state and a second state. The controller is configured to transition the theft detection device from the first state to the second state when the controller determines that the signal received by the receiver includes the predetermined code.

Another embodiment of the invention relates to a theft detection system. The theft detection system includes a theft detection device configured to be coupled to a product. The theft detection devices includes a receiver configured to receive a signal. The theft detection device includes a controller configured to determine whether the signal received by the receiver includes a code. The controller is configured to deactivate the theft detection device when the controller determines that the receiver has received a signal that includes the code. The theft detection system includes an emitter configured to emit a signal including the code.

In yet another aspect, an embodiment of the invention relates to a method of providing theft detection systems. The method includes providing a theft detection device configured to be coupled to a product. The theft detection device has a first state in which it is configured to detect theft and a second state in which it is not configured to detect theft. The theft detection device includes a receiver configured to receive a signal including a first code. The theft detection device includes a controller configured to determine whether to cause the theft detection device to enter the second state based on the signal received by the receiver. The method includes providing an emitter configured to emit the signal including the first code.

Other aspects, objectives and advantages of the invention will become more apparent from the following detailed description when taken in conjunction with the accompanying drawings.

### BRIEF DESCRIPTION OF THE DRAWINGS

This application will become more fully understood from the following detailed description, taken in conjunction with the accompanying figures, wherein like reference numerals refer to like elements in which:

FIG. 1 is a perspective view of an embodiment of a theft detection system including an embodiment of a theft detection device coupled to a product and an embodiment of a deactivator including an emitter;

FIG. 2 is a block diagram illustrating an embodiment of a theft detection device.

FIG. 3 is a block diagram illustrating another embodiment of a theft detection device.

FIG. 4 is a block diagram illustrating an embodiment of a deactivator;

FIG. 5 is a top perspective view of an embodiment of a theft detection device;

FIG. 6 a bottom perspective view of an embodiment of a theft detection device;

FIG. 7 is a flow diagram illustrating the process of deactivating a theft detection device;

FIG. 8 is a perspective view of another embodiment of a theft detection system including an embodiment of a theft detection device coupled to a product and an embodiment of a deactivator including an emitter;

FIG. 9 is a top view of the embodiment of the theft detection system illustrated in FIG. 8 illustrating the remover removing a tag from a product; and

FIG. 10 is a block diagram illustrating another embodiment of a theft detection device.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

Before turning to the figures, which illustrate the exemplary embodiments in detail, it should be understood that the present application is not limited to the details or methodology set forth in the description or illustrated in the figures.

Generally, theft deterrent devices may be coupled to products. The retail industry uses various products to remove and/or deactivate these theft deterrent devices when the product is purchased (e.g., when the product is brought to the checkout, the theft deterrent devices are deactivated and/or removed from the product). However, certain devices used to deactivate theft detection devices may be easily mimicked or duplicated. For example, some RF theft detection devices may be deactivated by an RF pulse used to burn out a diode in the RF theft detection devices. In another example, some AM theft detection devices may be demagnetized to deactivate the AM theft detection devices. Thus, thieves can obtain devices used to deactivate theft detection devices, deactivate the theft detection devices, and remove products from stores without paying and without detection of the theft.

Generally, in one embodiment theft detection systems described in the present disclosure include theft detection devices configured to be coupled to products. However, embodiments of theft detection devices may only be deactivated when receiving a signal including a predetermined code. Thus, only deactivators which are configured to emit a signal including the predetermined code are able to deactivate the theft detection devices (e.g., as opposed to previous magnetic detachers, deactivator pads, infrared remote controls, etc., which could be used to deactivate theft detection devices in any store).

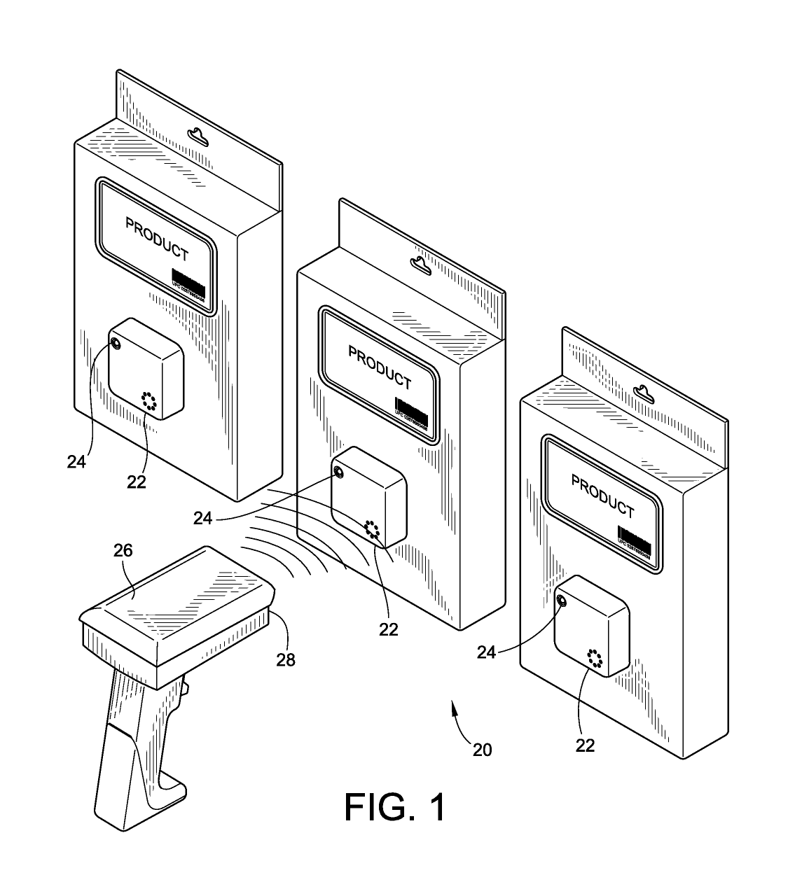

With reference to FIG. 1, an embodiment of a theft detection system 20 is illustrated. The theft detection system 20 includes a plurality of theft detection devices, illustrated in FIG. 1 as tags 22 configured to be coupled to products such as merchandise products (three are illustrated in FIG. 1, but this number is merely exemplary; any suitable number of tags 22 may be provided to be coupled to any suitable number of products). The tags 22 each include a receiver 24. The theft detection devices may be any suitable type of theft detection devices. For example, in one embodiment, the tags 22 may be theft detection devices such as those disclosed in U.S. patent application Ser. No. ______, entitled Theft Detection Device and Method for Controlling, filed concurrently herewith, and incorporated herein in its entirety by reference. In other embodiments, the tags 22 may be any suitable type of theft detection device configured to detect theft by any suitable mechanism.

The theft detection system 20 also includes a deactivator 26, illustrated in FIG. 1 as a hand-held, portable deactivator. The deactivator 26 includes an emitter 28. The deactivator 26 is configured to emit a signal including a code. The code may be a predetermined deactivate code. The signal including the code is emitted by the emitter 28 to the tags 22 to deactivate them (e.g., in one embodiment to configure the theft detection devices not to detect theft, in another embodiment to configure the theft detection devices not to emit an alarm signal, etc.). The deactivator 26 may be used, for example, by a store employee, upon purchase of a product to deactivate the tag 22 coupled to a purchased product. In one embodiment, upon deactivation, the tags 22 may be removed from the products. In another embodiment, the tags 22 remain coupled to the products in the deactivated state.

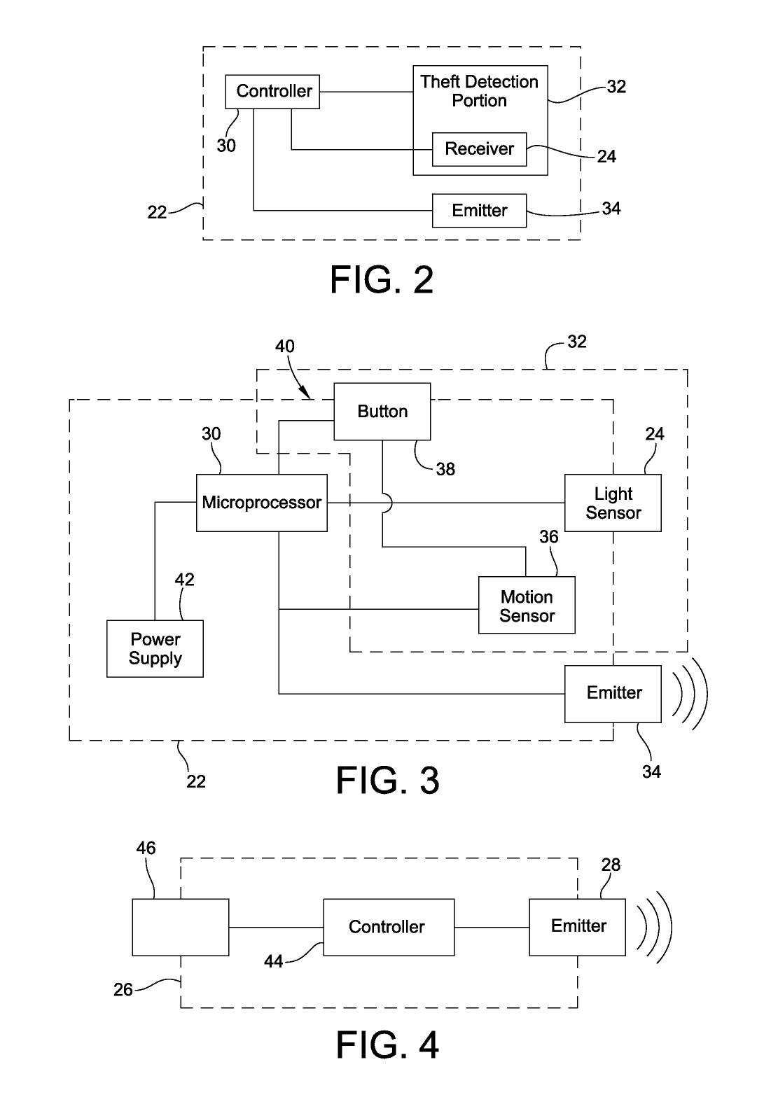

FIG. 2 illustrates a block diagram of an exemplary embodiment of a tag 22. The tag 22 includes a controller 30 electrically coupled to the receiver 24. The tag 22 also includes a theft detector 32, which in one embodiment includes the receiver 24, and is electrically coupled to the controller 30. The tag 22 also includes an emitter 34 electrically coupled to the controller 30. The controller 30 determines, based on the theft detector 32, whether the product that the tag 22 is coupled to is in a condition potentially indicative of theft of the product.

The receiver 24 is configured to receive a signal. The controller 30 determines whether a signal received by the receiver 24 includes a code, such as a predetermined deactivate code. When the controller 30 determines that the receiver 24 has received a signal containing the code, for a period of time (e.g., a set period of time, a period of time until a different condition is determined by the theft detection portion, etc.) the controller 30 no longer causes the emitter 34 to emit an alarm signal when the controller 30 determines based on the theft detection portion that the product that the tag 22 is coupled to is in a condition potentially indicative of theft of the product.

With reference to FIG. 3, in one embodiment, the receiver 24 is a light sensor. The theft detector 32 also includes a motion sensor 36 electrically coupled to the controller 30. The theft detector 32 also includes an indicator, illustrated in FIG. 3 as a button 38, electrically coupled to the controller 30. The button 38 projects past a surface 40 of the tag 22 configured to be coupled to a product. Thus, the button 38 is actuated when the tag 22 is coupled to a product and indicates to the controller 30 that the tag 22 is coupled to a product.

In one embodiment, the controller 30 determines whether the product to which the tag 22 is coupled is in a condition potentially indicative of theft based on the motion of the tag 22 sensed by the motion sensor 36 and the light level sensed by the receiver 24. For example, in one embodiment, if the motion sensor 36 senses that the tag 22 is in motion and the receiver 24 senses that the light level is below a predetermined light level for more than a predetermined time period, the controller 30 determines that the product that the tag 22 is coupled to is in a condition potentially indicative of theft of the product and causes the emitter 34 to emit an alarm signal. In other embodiments, the controller 30 may be configured to determine whether potential theft conditions exist by any suitable mechanism. For example, in one embodiment, the controller 30 may be configured to detect theft of a product by the method and mechanism described in U.S. patent application Ser. No. ______, entitled Theft Detection Device and Method for Controlling, filed concurrently herewith.

The receiver 24 is configured to receive a signal including a code, as will be discussed further below. In one embodiment, the receiver 24 is a light sensor configured to sense light. The controller 30 is configured to recognize whether the signal received by the receiver 24 includes the code. When the receiver 24 receives the signal, the controller 30 determines if the signal includes the code.

If the controller 30 determines the signal received by the receiver 24 includes the code, the controller transitions the tag 22 from a first state to a second state. In the first state, if the controller 30 determines from the theft detector 32 that the product that the tag 22 is coupled to is in a condition potentially indicative of theft of the product (e.g., if the button 38 indicates that the tag 22 had been removed from the product, if the motion sensor 36 and receiver 24 indicate a potential theft condition, etc.) the controller 30 would cause the emitter 34 to emit an alarm signal. However, in one embodiment, in the second state the controller 30 does not cause the emitter 34 to emit an alarm signal when a condition potentially indicative of theft of the product is detected. In another embodiment, in the second state the controller 30 does not monitor the theft detector 32 for conditions potentially indicative of theft of the product.

In one embodiment, the controller 30 transitions the tag 22 from the second state to the first state when it detects based on the button 38 that the tag 22 has been coupled to a product.

In one embodiment, the controller 30 causes the emitter 34 to emit a first confirmation signal when the controller 30 determines that the receiver 24 has received a signal with the code. In one embodiment, the controller 30 causes the emitter 34 to emit a second confirmation signal to indicate that the controller 30 has transitioned the tag 22 from the second state to the first state.

In one embodiment, the emitter 34 is an audible signal emitter and the first and second confirmation signals are audible signals. In another embodiment, the emitter 34 includes a light emitter and the first and second confirmation signals are visible light signals. In one embodiment, the first and second confirmation signals are the same.

In one embodiment, the tag 22 includes a power supply 42 electrically coupled to the controller 30. In one embodiment, the power supply 42 is a battery. In another embodiment, the power supply 42 is a solar cell. In other embodiments, the power supply 42 may be any suitable power supply.

With reference to FIG. 4, a block diagram of an embodiment of a deactivator 26 is illustrated. The deactivator 26 includes a controller 44. The controller 44 is electrically coupled to a trigger 46. The deactivator 26 also includes the emitter 28 electrically coupled to the controller 44. The controller 44 is configured to cause the emitter 28 to emit a signal containing the code when the trigger 46 is actuated.

In one embodiment, the emitter 28 is a light emitter. The controller 44 is configured to cause the emitter 28 to emit a light signal. In one embodiment the signal is a light pattern. The light pattern may be light dispersed over a time period, over physical space, over various wavelengths, over various frequencies, over various amplitudes, etc.

For example, in one embodiment when the trigger 46 is actuated, the controller 44 controls the emitter 28 to emit light and then not emit light a series of times for predetermined amounts of times (e.g., a predetermined flashing light pattern) to transmit a signal including the code to be received by the receiver 24 and recognized by the controller 30 of the tag 22 to transition the tag 22 from the first state to the second state.

In another embodiment, when the trigger 46 is actuated, the controller 44 controls the emitter 28 to emit a light signal including light spaced apart spatially in a predetermined pattern forming the code to be received by the receiver 24 and recognized by the controller 30.

In another embodiment, when the trigger 46 is actuated, the controller 44 controls the emitter 28 to emit a light signal having various characteristics (e.g., a predetermined frequency of light, predetermined frequency variations, a predetermined wavelength of light, predetermined wavelength variations, a predetermined amplitude of light, predetermined amplitude variations, combinations of these, etc.) to include the code in the signal to be received by the receiver 24 and recognized by the controller 30.

In one embodiment, the controller 44 can be configured to cause the emitter 28 to emit a signal including any suitable code. In another embodiment, the controller 44 can be reconfigured to cause the emitter 28 to emit a signal including a different suitable code.

Referring to FIG. 3, in one embodiment, the controller 30 can be programmed to recognize the code prior to the tag 22 being put into use. In one embodiment, the controller 30 may be reconfigured to recognize a different code. Thus, tags 22 may be provided to different stores, such as retail stores, to be coupled to products. The tags provided to different stores may have controllers configured to recognize different codes. Each store, or group of stores, may have its own tags 22 configured to be deactivated only by signals including the stores' own code or codes. This may prevent a thief from using a deactivator 26 from one store to deactivate tags at another store.

Additionally, in one embodiment the controllers 30 of tags 22 to be coupled to different products may be configured to recognize different codes (e.g., codes specific to the type of product to which the tag 22 is coupled).

In one embodiment, the emitter 28 is a visible light emitter. In another embodiment, the emitter 28 is an infrared light emitter. In another embodiment, the emitter 28 may emit any suitable type of light.

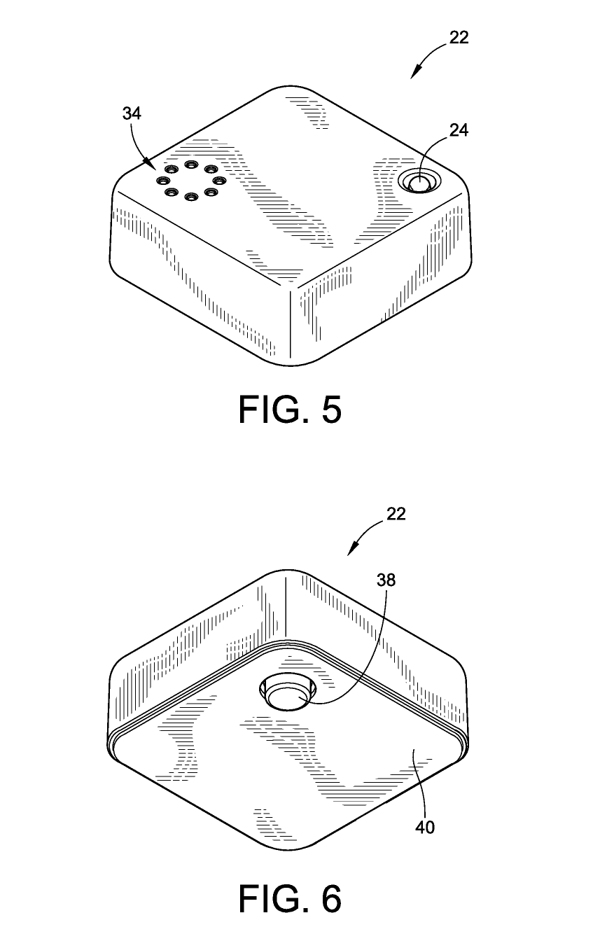

FIGS. 5 and 6 illustrate one embodiment of a tag 22. The tag 22 includes the receiver 24 and the emitter 28. The tag 22 also includes the button 38 projecting through the surface 40 of the tag 22 configured to be coupled to a product.

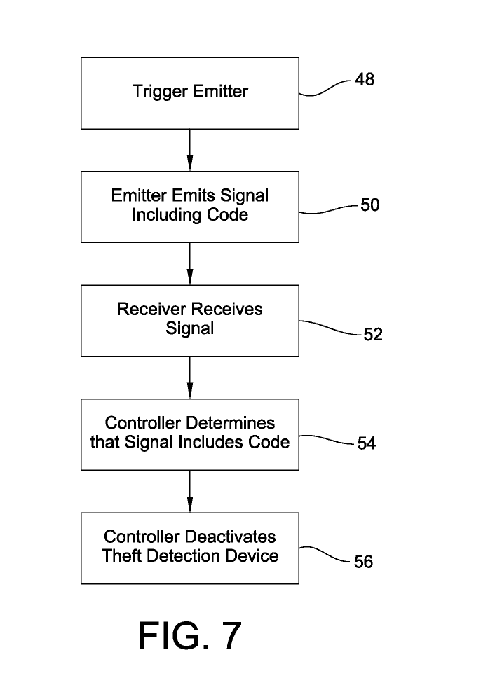

With reference to FIG. 7, the steps of one embodiment of a method of deactivating a theft detection device are illustrated. In step 48, the trigger 46 of the deactivator 26 is actuated causing the controller 44 to trigger the emitter 28. In step 50, the emitter 28 emits a signal including the code which the controller 44 is programmed to cause the emitter 28 to emit. In step 52, the receiver 24 of the tag 22 receives the signal emitted by the emitter 28. In step 54, the controller 30 of the tag 22 determines that the signal received by the receiver 24 contains the code. In step 56, the controller 44 deactivates the tag 22.

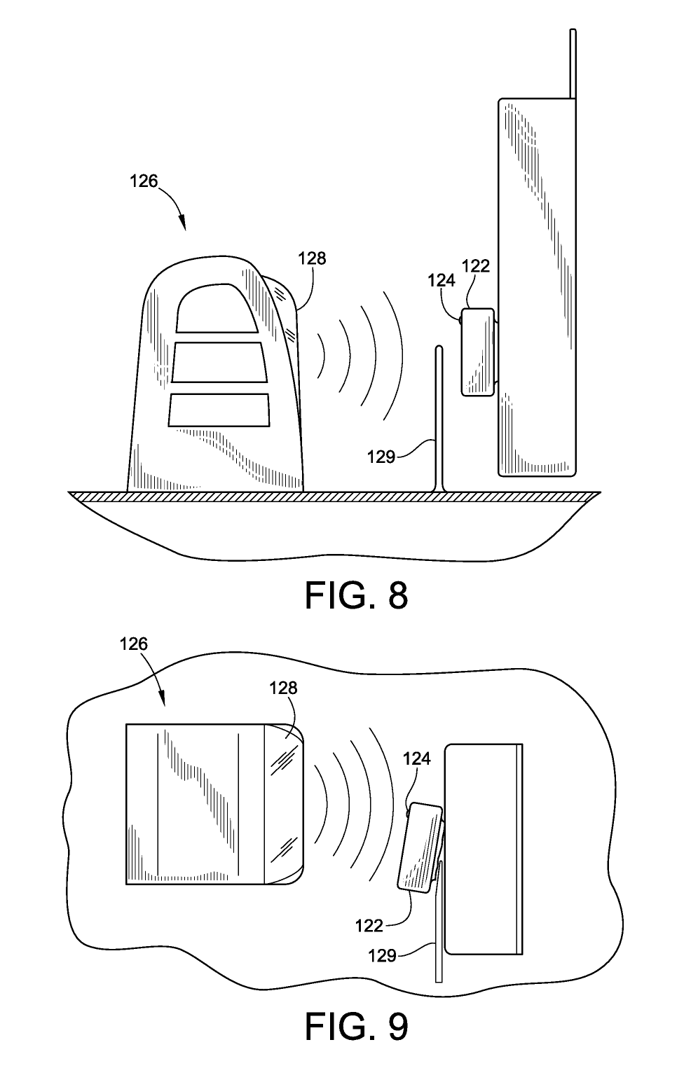

FIG. 8 illustrates another embodiment of a theft detection system 120. The theft detection system 120 includes a theft detection device, illustrated in FIG. 8 as a tag 122. The tag 122 includes a receiver 124 configured to receive a signal including a predetermined code. The theft detection system 120 also includes a deactivator 126 including an emitter 128. The deactivator 126 is configured to emit a signal including a predetermined code. The theft detection system 120 includes many of the same features and operates similarly to the theft detection system 20. Some differences between the embodiments are described.

In the embodiment illustrated in FIG. 8, the deactivator 126 is configured to be mounted in place, for example, mounted to a floor, counter, checkout station, or other suitable apparatus. The deactivator 126 also includes a remover 129. The remover 129 is configured to remove or to be used by a user (e.g., store personnel) to remove the tag 122 from the product after the emitter 128 has emitted a signal including the predetermined code to deactivate the tag 122. In one embodiment, the remover 129 is a projection configured to be inserted between the tag 122 and the product to remove the tag 122 from the product, as illustrated in FIG. 9. In other embodiments, the remover 129 may be any apparatus suitable for removing the tag 122 from the product. In one embodiment, the emitter 128 and the remover 129 are arranged and configured such that a product with a tag 122 attached to it can be slid past the emitter 128 and the remover 129 to deactivate and remove the tag 122 from the product all at once, e.g., in a single motion by the store personnel, as illustrated in FIG. 9.

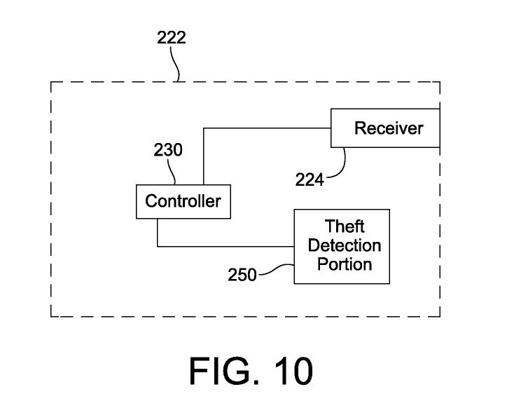

With reference to FIG. 10, in another embodiment a theft detection device, illustrated as a tag 222, is provided. When the tag 222 is in an active state, the tag 222 is configured to be detected by an EAS system, such as, for example, when the tag 222 passes through the gates of an EAS system. When the tag 222 is not in an active state, the tag 222 is configured not to be detected by an EAS system. The tag 222 includes a receiver 224 electrically coupled with a controller 230. The receiver 224 is configured to receive a signal including a predetermined code. The controller 230 is configured to determine whether the signal received by the receiver 223 includes the predetermined code. The tag 222 also includes a detection portion 250. The detection portion 250 is configured to be detected by the EAS system when the tag is in an active state.

In one embodiment, the tag 222 is configured to be used in a magnetic EAS system and the detection portion 250 includes a ferromagnetic material. When the controller 230 determines that the receiver 224 has received a signal containing the predetermined code, the controller 230 causes the tag 222 to switch to the deactive state by rendering the detection portion 250 undetectable by the magnetic EAS system detection gates, e.g., by demagnetizing the ferromagnetic material or any other suitable mechanism.

In another embodiment, the tag 222 is configured to be used in an acousto-magnetic EAS system and the detection portion 250 is configured to be detected by the acousto-magnetic EAS system detection gates when the tag 222 is in an active state. When the controller 230 determines that the receiver 224 has received a signal containing the predetermined code, the controller 230 causes the tag 222 to switch to the deactive state by rendering the detection portion 250 undetectable by the acousto-magnetic EAS system detection gates by any suitable mechanism.

In another embodiment, the tag 222 is configured to be used in a radio-frequency EAS system and the detection portion 250 is configured to be detected by the radio-frequency EAS system detection gates when the tag 222 is in an active state. When the controller 230 determines that the receiver 224 has received a signal containing the predetermined code, the controller 230 causes the tag 222 to switch to a deactive state by rendering the detection portion 250 undetectable by the radio-frequency EAS system detection gates. In one embodiment, when the controller switches the tag 222 to a deactive state, it temporarily (e.g., non-permanently) renders the detection portion 250 undetectable by the radio-frequency EAS system detection gates (e.g., disabling capacitor in detection portion 250, etc.). In one embodiment, the controller 230 is also configured to return the tag 222 from the deactive state back to the active state in which the detection portion 250 is detectable by the radio-frequency EAS system detection gates.

In another embodiment, the tag 222 is configured to be used in a microwave EAS system and the detection portion 250 is configured to be detected by the microwave EAS system detection gates when the tag 222 is in an active state. When the controller 230 determines that the receiver 224 has received a signal containing the predetermined code, the controller 230 causes the tag 222 to switch to a deactive state by rendering the detection portion 250 undetectable by the microwave EAS system detection gates. In one embodiment, when the controller switches the tag 222 to a deactive state, it temporarily (e.g., non-permanently) renders the detection portion 250 undetectable by the microwave EAS system detection gates. In one embodiment, the controller 230 is also configured to return the tag 222 from the deactive state back to the active state in which the detection portion 250 is detectable by the microwave EAS system detection gates.

In each of the embodiments described above, the controller 230 may be configured to recognize various different predetermined codes. Thus, in one embodiment different stores may have theft detection devices that recognize different, predetermined, unique codes, and a deactivator not configured to emit the correct predetermined code for the particular store will be unable to deactivate a theft detection device configured to recognize the correct predetermined code for the particular store.

In another embodiment, the emitter 28 is a radio frequency (RF) emitter configured to emit an RF signal and the receiver 24 is an RF receiver configured to receive an RF signal. In other embodiments, the emitter may be configured to emit other suitable electromagnetic signals and the receiver may be configured to receive other suitable types of electromagnetic signals.

In one embodiment, the tag 22 includes any suitable type of memory into which the code may be stored. In one embodiment, the memory is internal to the controller 30.

In one embodiment the theft detection device is a tag. In another embodiment, the theft detection device is a wired alarm clip. In other embodiments, the theft detection device may be any suitable theft detection mechanism.

While the indicator of the tag 22 is illustrated in FIG. 3 as a button, this is merely exemplary. In other embodiments, the indicator may be any indicator suitable to indicate to the controller 30 whether the tag 22 is coupled to a product.

The trigger 46 described above may be any mechanism suitable to trigger the controller 44 to cause the emitter to emit the signal including the code.

In one embodiment the light emitter is a visible light emitter and the receiver is a light sensor (e.g., photocell, light dependent resistor, photodiode, phototransistor, photovoltaic cell, etc.). In one embodiment, the light emitter is a UV light emitter and the receiver is a light sensor configured to receive UV light. In another embodiment, the light emitter is an infrared light emitter and the receiver is a light sensor configured to receive infrared light. In other embodiments, the light emitter may emit any suitable type of light (e.g., combinations of different types of light, etc.) and the receiver is a light sensor configured to receive the type or types of light emitted by the light emitter).

In one embodiment, deactivating a tag 22 means that the controller 30 does not cause the emitter 34 to emit an alarm signal when the controller 30 recognizes a condition potentially indicative of theft of the product to which the tag 22 is coupled. In another embodiment, deactivating a tag 22 means that the controller 30 does not monitor the theft detector 32 to determine whether a condition potentially indicative of theft of the product exists.

In the embodiment illustrated in FIG. 2, the tag 22 includes the receiver 24, which in one embodiment is a light sensor, and the motion sensor 34. The microprocessor 30 is configured to determine, based on the light level sensed by the receiver 24 and the motion of the tag 22 sensed by the motion sensor 34, whether the product the tag 22 is coupled to is potentially being stolen. Thus, in one embodiment, the receiver 24 is configured both to receive a signal including a predetermined code and to assist in detecting potential theft conditions, such as, e.g., a light level below a predetermined light level. In another embodiment, the tag 22 includes separate receivers for receiving a signal including a predetermined code and for assisting in detecting potential theft conditions, such as, e.g., a light level below a predetermined light level.

In another embodiment, the tag 22 includes a theft detection unit electrically coupled to the microprocessor 30. The theft detection unit may be any suitable type of theft detection unit configured to detect theft of the product that the tag is coupled to by any suitable mechanism and any suitable method.

In one embodiment, the controllers described above are microprocessors. In other embodiments, the controllers may be any suitable type of controller. In one embodiment, the embodiments of methods described above may be implemented via hardware, firmware, software, or any other suitable implementation.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A theft detection system comprising:
a theft detection device configured to be coupled to a product, the theft detection device including a receiver configured to receive a signal, and a controller;
wherein the controller is configured to determine whether the signal received by the receiver includes a code;
wherein the theft detection device has a first state and a second state; and
wherein the controller is configured to transition the theft detection device from the first state to the second state when the controller determines that the signal received by the receiver includes the predetermined code.

2. The theft detection system of claim 1, wherein the theft detection device includes an alarm emitter;
wherein when the theft detection device is in the first state, the controller causes the alarm emitter to emit an alarm signal when the theft detection system is not coupled to a product; and
wherein when the theft detection device is in the second state, the controller does not cause the alarm emitter to emit an alarm signal when the theft detection system is not coupled to a product.

3. The theft detection system of claim 1, further comprising an emitter configured to emit a signal including the code;
wherein the emitter is a light emitter configured to emit a signal including the code by turning on and off a plurality of times.

4. The theft detection system of claim 1, wherein the theft detection device includes a sound emitter;
wherein the receiver is a light sensor; and
wherein the controller causes the sound emitter to emit an indicator sound to indicate the transition of the theft detection device from the first state to the second state.

5. A theft detection system comprising:
a theft detection device configured to be coupled to a product, the theft detection device including a receiver configured to receiver a signal and a controller configured to determine whether the signal received by the receiver includes a code, the controller being configured to deactivate the theft detection device when the controller determines that the receiver has received a signal that includes the code; and
an emitter configured to emit a signal including the code.

6. The theft detection system of claim 5, wherein the receiver of the theft detection device is a light sensor configured to sense a light level.

7. The theft detection system of claim 6, wherein emitter is a light emitter; and
wherein the emitter emits a signal including the code by turning on for a first time period, turning off for a second time period, and turning on for a third time period.

8. The theft detection system of claim 6, wherein the theft detection device includes an alarm emitter and a motion sensor configured to determine when the theft detection device is in motion; and
wherein the theft detection device is configured to emit an alarm signal when the theft detection device is in motion and the light level sensed by the light sensor is below a predetermined level for more than a predetermined time period.

9. The theft detection system of claim 5, wherein the controller is configured to be reprogrammed with a second code.

10. The theft detection system of claim 9, wherein the emitter is reconfigurable to emit the second code.

11. The theft detection system of claim 5, wherein the emitter includes an trigger configured to be actuated to cause the emitter to emit a signal including the code.

12. The theft detection system of claim 5, wherein the controller does not deactivate the theft detection device if a signal received by the receiver does not include the code.

13. The theft detection system of claim 5, wherein the emitter is a radio frequency signal emitter; and
wherein the receiver is configured to receive a radio frequency signal.

14. A method of providing theft detection systems comprising:
providing a theft detection device configured to be coupled to a product, the theft detection device having a first state in which it is configured to detect theft and a second state in which it is not configured to detect theft, the theft detection device including a receiver configured to receive a signal including a first code and a controller configured to determine whether to cause the theft detection device to enter the second state based on the signal received by the receiver; and
providing an emitter configured to emit the signal including the first code.

15. The method of claim 14, wherein the receiver is a light sensor; and
wherein the emitter is a light emitter.

16. The method of claim 15, wherein the signal emitted by the emitter comprises a light pattern.

17. The method of claim 16, wherein the signal emitted by the first emitter comprises a first predetermined period of light emission, followed by a second predetermined period of not emitting light, followed by a third predetermined period of light emission.

18. The method of claim 14 wherein the controller is configured to be reprogrammed to cause the theft detection device to enter the second state when the receiver receives a signal containing a second code different from the first code.

19. The method of claim 14, wherein the theft detection device includes an alarm emitter and an indicator configured to indicate to the controller whether the theft detection device is coupled to a product;
wherein the alarm emitter is configured to emit an alarm signal when the theft detection device is in the first state and the indicator indicates that the theft detection device is not coupled to a product.

20. The method of claim 14, further comprising providing a remover configured to remove the theft detection device from a product after the theft detection device enters the second state.
